(19) United States
(12) Patent Application Publication
(10) Pub. No.: US 2020/0008194 A1
(43) Pub. Date: Jan. 2, 2020

(54) SLOT ALLOCATION FOR MULTIPLE GROUPS OF OVERLAPPING CHANNELS

(71) Applicant: QUALCOMM Incorporated, San Diego, CA (US)

(72) Inventors: Yi HUANG, San Diego, CA (US); Peter GAAL, San Diego, CA (US); Wanshi CHEN, San Diego, CA (US); Wei YANG, San Diego, CA (US)

(21) Appl. No.: 16/453,491

(22) Filed: Jun. 26, 2019

Related U.S. Application Data
(60) Provisional application No. 62/692,275, filed on Jun. 29, 2018.

(51) Int. Cl. H04W 72/04

(52) U.S. Cl. CPC H04W 72/0446; H04W 72/0413

(57) ABSTRACT

Certain aspects of the present disclosure provide techniques for transmitting uplink control information (UCI) in a single time slot comprising two or more groups of overlapping channels by a user equipment (UE), the two or more groups of overlapping channels comprising a first group and a second group, the first group comprising a first plurality of channels that overlap in time, the second group comprising a second plurality of channels that overlap in time, wherein the first group and the second group do not overlap in time. The method further includes determining if a first earliest symbol in time corresponding to the first group meets at least a first timeline requirement and a second timeline requirement and if a second earliest symbol in time corresponding to the second group meets at least a third timeline requirement and a fourth timeline requirement. The method further includes multiplexing and transmitting the UCI.

### CROSS-REFERENCE TO RELATED APPLICATIONS

This application claims benefit of and priority to: U.S. Provisional Patent Application Ser. No. 62/692,275 filed Jun. 29, 2018, which is incorporated by reference herein in its entirety as if fully set forth below and for all applicable purposes.

### INTRODUCTION

### Field of the Disclosure

Aspects of the present disclosure relate to wireless communications, and more particularly, to techniques for slot allocation for multiple groups of overlapping channels.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., which may be referred to as a base station, 5G NB, next generation NodeB (gNB or gNodeB), TRP, etc.). A base station or distributed unit may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. New Radio (NR) (e.g., 5G) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication. The method generally includes transmitting uplink control information (UCI) in a single time slot including two or more groups of overlapping channels by a user equipment, the two or more groups of overlapping channels including a first group and a second group, the first group including a first plurality of channels that overlap in time, the second group including a second plurality of channels that overlap in time, wherein the first group and the second group do not overlap in time. The method further includes determining if a first earliest symbol in time corresponding to the first group meets at least a first timeline requirement and a second timeline requirement. The method further includes determining if a second earliest symbol in time corresponding to the second group meets at least a third timeline requirement and a fourth timeline requirement. The method further includes multiplexing and transmitting a first plurality of uplink control information (UCI) on a first channel of the first plurality of channels; and multiplexing and transmitting a second plurality of UCI on a second channel of the second plurality of channels when the first earliest symbol meets the first timeline requirement and the second timeline requirement and the second earliest symbol meets the third timeline requirement and fourth timeline requirement.

Certain aspects provide a non-transitory computer readable storage medium that stores instructions that when executed by a user equipment cause the user equipment to perform a method of transmitting uplink control information (UCI) in a single time slot comprising two or more groups of overlapping channels by a user equipment, the two or more groups of overlapping channels comprising a first group and a second group, the first group comprising a first plurality of channels that overlap in time, the second group comprising a second plurality of channels that overlap in time, wherein the first group and the second group do not overlap in time. The method further includes determining if a first earliest symbol in time corresponding to the first group meets at least a first timeline requirement and a second timeline requirement. The method further includes determining if a second earliest symbol in time corresponding to the second group meets at least a third timeline requirement and a fourth timeline requirement. The method further includes, when the first earliest symbol meets the first timeline requirement and the second timeline requirement and the second earliest symbol meets the third timeline requirement and fourth timeline requirement: multiplexing and transmitting a first plurality of uplink control information (UCI) on a first channel of the first plurality of channels, and multiplexing and transmitting a second plurality of UCI on a second channel of the second plurality of channels.

Certain aspects provide a user equipment including a means for transmitting uplink control information (UCI) in a single time slot comprising two or more groups of overlapping channels by a user equipment, the two or more groups of overlapping channels comprising a first group and a second group, the first group comprising a first plurality of channels that overlap in time, the second group comprising a second plurality of channels that overlap in time, wherein the first group and the second group do not overlap in time. The user equipment further includes a means for determining if a first earliest symbol in time corresponding to the first group meets at least a first timeline requirement and a second timeline requirement. The user equipment further includes a means for determining if a second earliest symbol in time corresponding to the second group meets at least a third timeline requirement and a fourth timeline requirement. The user equipment further includes, when the first earliest symbol meets the first timeline requirement and the second timeline requirement and the second earliest symbol meets the third timeline requirement and fourth timeline requirement: a means for multiplexing and transmitting a first plurality of uplink control information (UCI) on a first channel of the first plurality of channels, and a means for multiplexing and transmitting a second plurality of UCI on a second channel of the second plurality of channels.

Certain aspects provide a user equipment including a memory, and a processor configured to transmit uplink control information (UCI) in a single time slot comprising two or more groups of overlapping channels, the two or more groups of overlapping channels comprising a first group and a second group, the first group comprising a first plurality of channels that overlap in time, the second group comprising a second plurality of channels that overlap in time, wherein the first group and the second group do not overlap in time. The user equipment including a memory and a processor is further configured to determine if a first earliest symbol in time corresponding to the first group meets at least a first timeline requirement and a second timeline requirement. The user equipment including a memory and a processor is further configured to determine if a second earliest symbol in time corresponding to the second group meets at least a third timeline requirement and a fourth timeline requirement. The user equipment including a memory and a processor is further configured to: when the first earliest symbol meets the first timeline requirement and the second timeline requirement and the second earliest symbol meets the third timeline requirement and fourth timeline requirement, multiplex and transmit a first plurality of uplink control information (UCI) on a first channel of the first plurality of channels, and multiplex and transmit a second plurality of UCI on a second channel of the second plurality of channels.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 illustrates an example of a frame format for a new radio (NR) system, in accordance with certain aspects of the present disclosure.

FIG. 4A is a block diagram conceptually illustrating slot allocation for a single group of overlapping channels in accordance with certain aspects of the present disclosure.

FIG. 4B is a block diagram conceptually illustrating slot allocation for multiple groups of overlapping channels in accordance with certain aspects of the present disclosure.

FIG. 4C is a block diagram conceptually illustrating slot allocation for multiple groups of overlapping channels in accordance with certain aspects of the present disclosure.

FIG. 4D is a block diagram conceptually illustrating slot allocation for multiple groups of overlapping channels in accordance with certain aspects of the present disclosure.

FIG. 5 is a flow chart conceptually illustrating slot allocation for multiple groups of overlapping channels in accordance with certain aspects of the present disclosure.

FIG. 6 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for slot allocation for multiple groups of overlapping channels.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

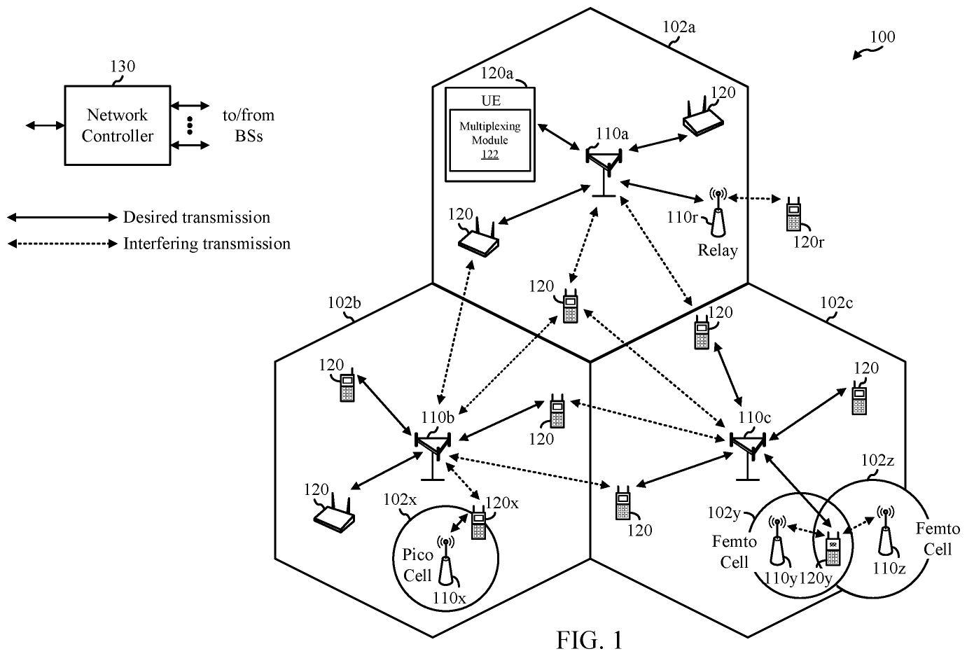

FIG. 1 illustrates an example wireless communication network 100 in which aspects of the present disclosure may be performed. For example, the wireless communication network 100 may be a New Radio (NR) or 5G network.

As illustrated in FIG. 1, the wireless network 100 may include a number of base stations (BSs) 110 and other network entities. A BS may be a station that communicates with user equipment (UEs). Each BS 110 may provide communication coverage for a particular geographic area. In 3GPP, the term “cell” can refer to a coverage area of a Node B (NB) and/or a Node B subsystem serving this coverage area, depending on the context in which the term is used. In NR systems, the term “cell” and next generation NodeB (gNB), new radio base station (NR BS), 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A base station (BS) may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. ABS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some aspects, a UE 120a may include a multiplexing module 122 configured to support transmission of uplink data (e.g., UCI) corresponding to two or more uplink channels that have overlapping time resources (e.g., symbols). In some examples, the multiplexing module 122 is configured to multiplex the uplink data using various multiplexing techniques, which conceptually places the data associated with the group of overlapping channels into one of the overlapping channels for the UE 120a to transmit the data in a single time slot. For example, if a control channel (e.g., PUCCH) overlaps in time with a data channel (e.g., PUSCH), the multiplexing module 122 multiplexes the control channel data and the data channel data before transmitting the multiplexed data to a BS 110 in one of the overlapping channels (e.g., on the data channel).

In some configurations, the multiplexing module 122 is also configured to determine whether timing constraints allow the uplink data to be processed and transmitted over the two or more overlapping channels. If the timing constraints are met, the UE 120a will transmit the UCI. If the timing constraints are not met, the UE 120a may consider the plurality of overlapping channels as an error condition (e.g., no data transmitted).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled, wherein a. A scheduling entity (e.g., a base station) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

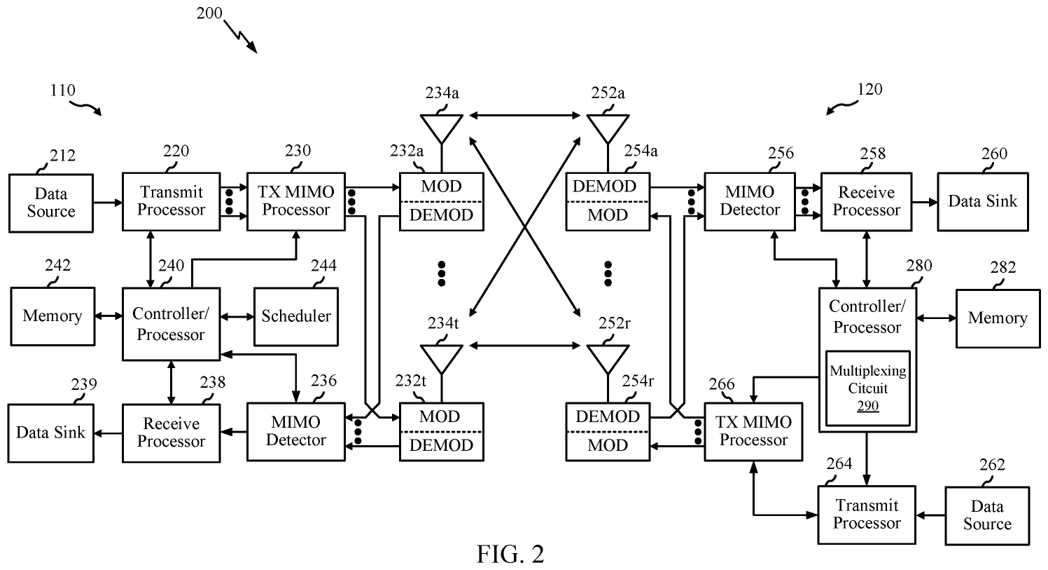

FIG. 2 illustrates example components 200 of BS 110 and UE 120 (as depicted in FIG. 1), which may be used to implement aspects of the present disclosure. For example, antennas 252, processors 266, 258, 264, and/or controller/processor 280 of the UE 120 and/or antennas 234, processors 220, 260, 238, and/or controller/processor 240 of the BS 110 may be used to perform the various techniques and methods described herein.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The processor 220 may also generate reference symbols, e.g., for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the base station 110 and may provide received signals to the demodulators (DEMODs) in transceivers 254a through 254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a through 254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

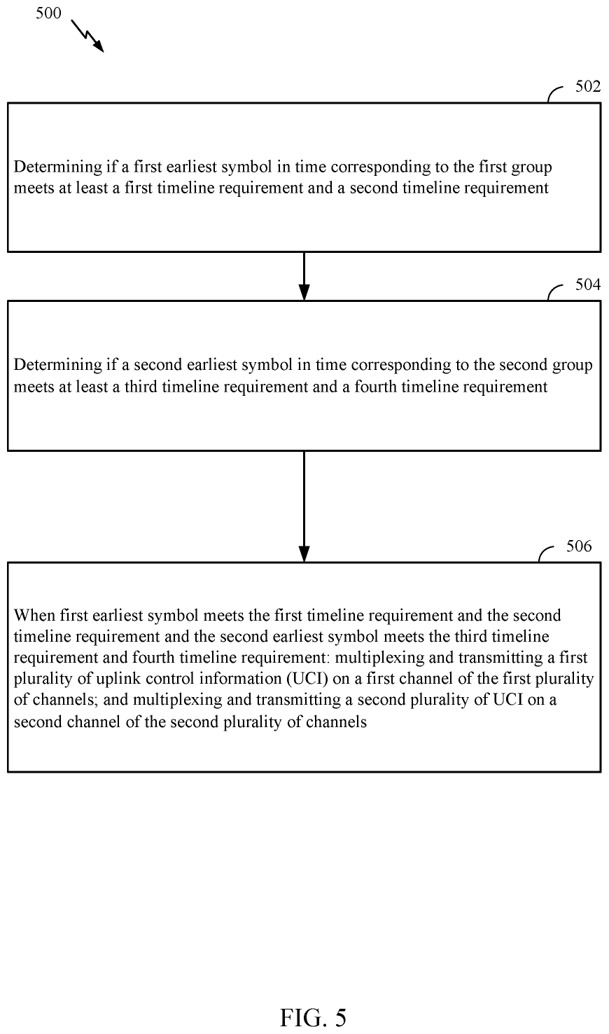

The controllers/processors 240 and 280 may direct the operation at the base station 110 and the UE 120, respectively. In some aspects, the controller/processor 280 of the UE 120 may include a multiplexing circuit 290 configured to support transmission of uplink data (e.g., UCI) corresponding to two or more uplink channels that have overlapping time resources (e.g., symbols). For example, the multiplexing circuit 290 may be configured to perform the operations illustrated in FIG. 5, or other operations for performing the various techniques discussed herein.

In some configurations, multiplexing circuit 290 is configured to multiplex the uplink data using various multiplexing techniques, which conceptually places the data associated with the group of overlapping channels into one of the overlapping channels for the UE 120 to transmit the data in a single time slot. For example, if a control channel (e.g., PUCCH) overlaps in time with a data channel (e.g., PUSCH), the multiplexing module 122 multiplexes the control channel data and the data channel data before transmitting the multiplexed data to a BS 110 in one of the overlapping channels (e.g., on the data channel).

In some configurations, the multiplexing circuit 290 is also configured to determine whether timing constraints allow the uplink data to be processed and transmitted over the two or more overlapping channels. If the timing constraints are met, the UE 120 will transmit the UCI. If the timing constraints are not met, the UE 120 may consider the plurality of overlapping channels as an error condition (e.g., no data transmitted).

The processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink.

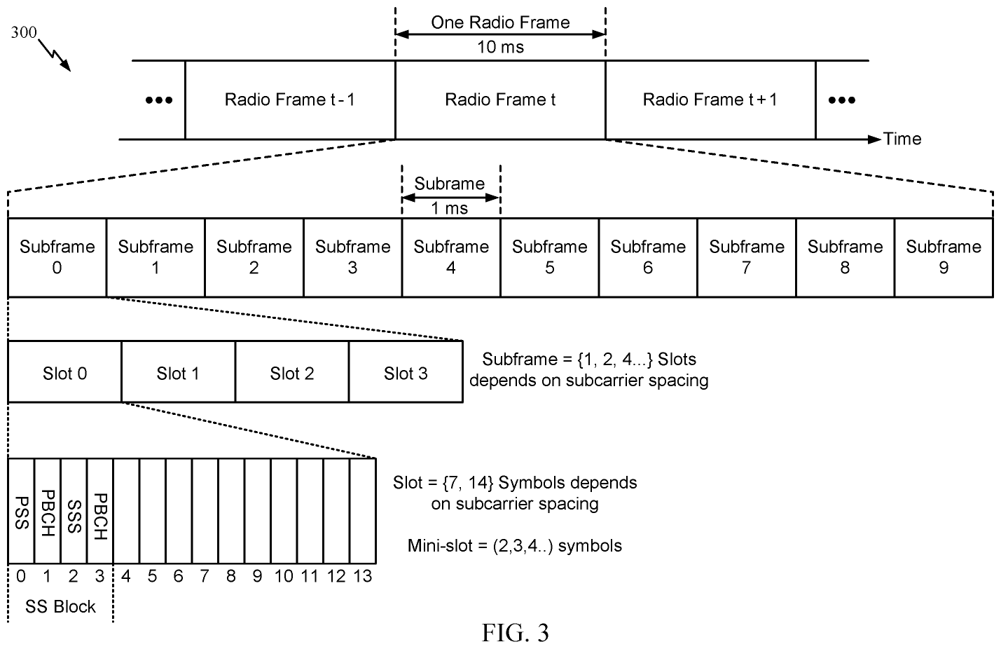

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Wireless Communication System with Single-Slot Allocation for Multiple Groups of Overlapping Channels

Wireless communication devices are capable of communicating on multiple uplink channels (e.g., physical uplink control channel (PUCCH), physical uplink shared channel (PUSCH), etc.), which operate on one or more frequencies that overlap in time (referred to herein as overlapping channels). In certain aspects, when a UE can transmit uplink control information (UCI) on two or more overlapping channels in a single time slot on an UL, the UE will determine whether timing constraints allow the UCI to be processed and sent on the two or more overlapping channels. If the timing constraints are met, the UE will transmit the UCI. If the timing constraints are not met, the UE may consider the plurality of overlapping channels as an error condition (e.g., no data transmitted).

In certain aspects, when a UE can transmit data (e.g., UCI) corresponding to two or more overlapping channels (or a group of overlapping channels) on an uplink (UL), the UE will multiplex the data using various multiplexing techniques, which conceptually places the data associated with the group of overlapping channels into one of the overlapping channels for the UE to transmit the data in a single time slot. For example, if a control channel (e.g., PUCCH) overlaps in time with a data channel (e.g., PUSCH), a UE may multiplex the control channel data and the data channel data before transmitting the multiplexed data to a BS in one of the overlapping channels (e.g., on the data channel).

UCI (e.g., for slot based scheduling) is often under one slot length in time and capable of being transmitted to a BS on one or more uplink channels. UCI can include one or more of a hybrid automatic repeat request acknowledgement (HARQ-ACK), scheduling requests (SRs), channel status information (CSI) (e.g., periodic channel status information (P-CSI) or aperiodic channel status information (A-CSI)), etc. In certain aspects, CSI includes one or more of (e.g., channel quality information (CQI), rank indicator (RI), precoding matrix indicator (PMI), etc.). UCI may be carried in two or more symbols of a PUCCH and/or a PUSCH slot. It will be appreciated that a plurality of UCI is capable of being multiplexed into a single slot of a PUCCH and/or a PUSCH transmission. It will be appreciated that the disclosure identifies certain UCI, however, the disclosure relates to any data capable of being multiplexed with other data in to a single slot as described below.

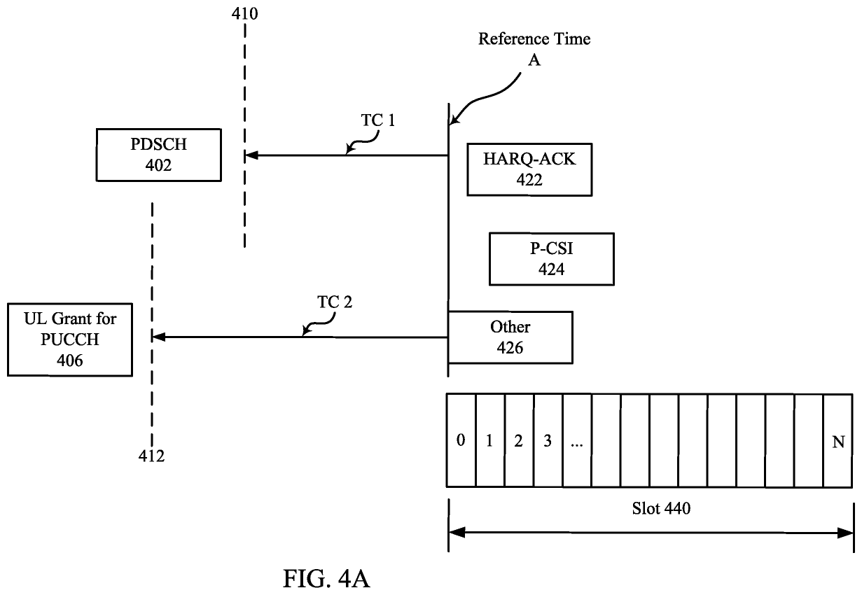

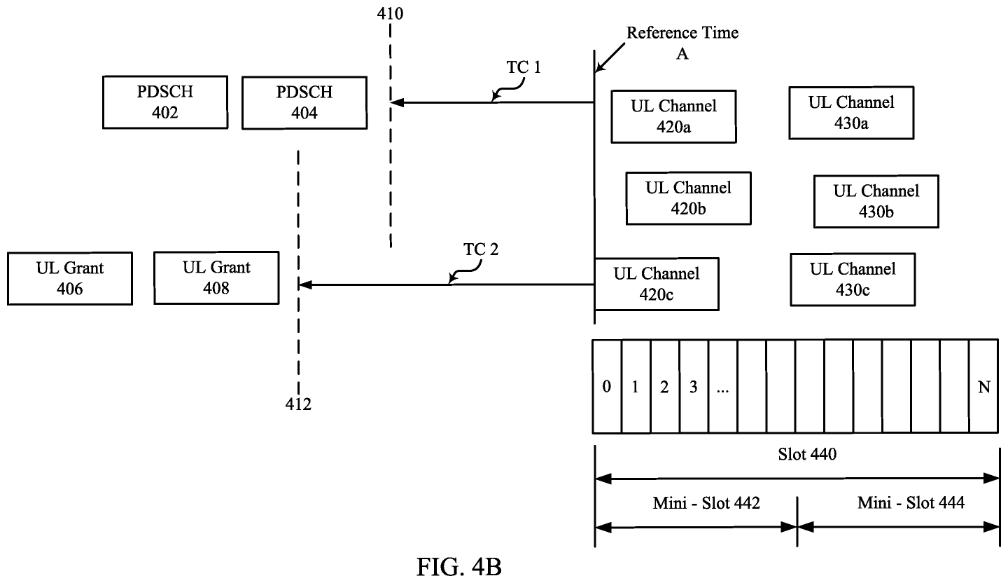

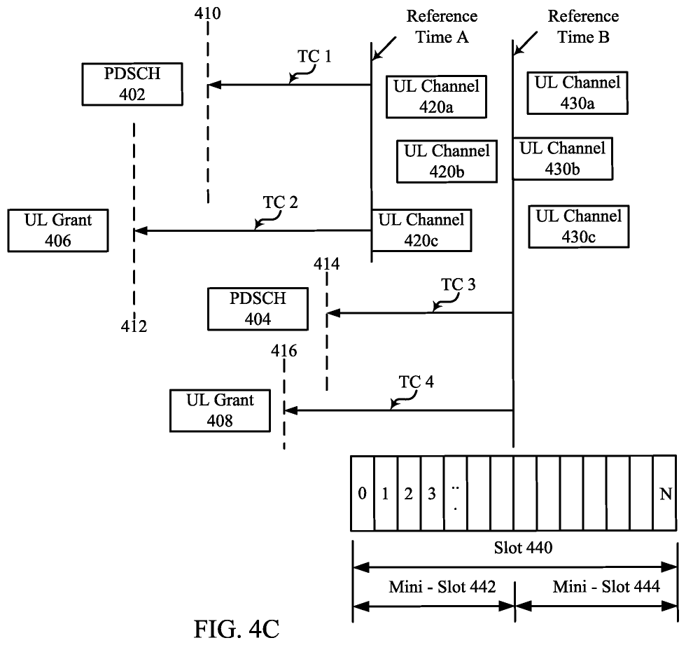

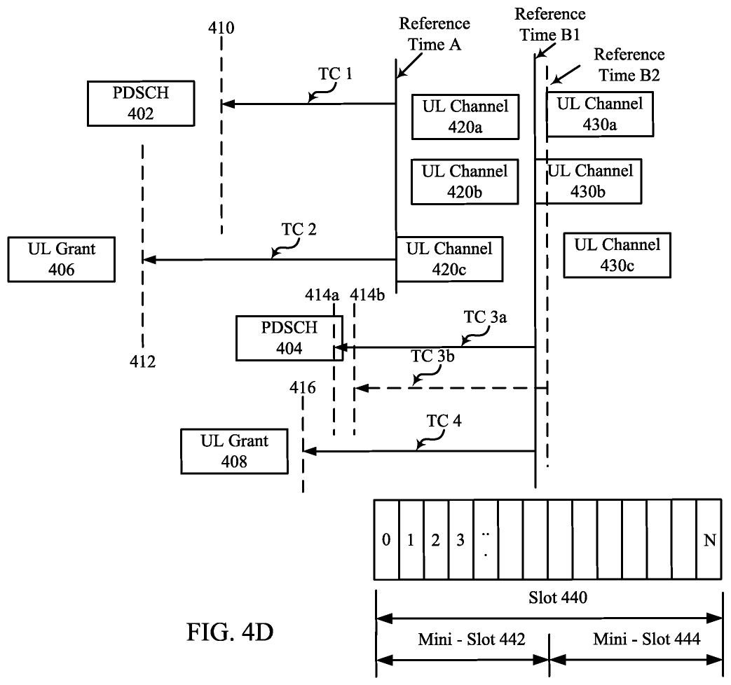

FIG. 4A is a block diagram conceptually illustrating slot allocation for a single group of overlapping channels. FIG. 4A shows three uplink channels 422, 424, and 426. In certain embodiments, the first uplink channel 422 (e.g., a PUCCH uplink channel) is associated with a first uplink channel frequency and a HARQ-ACK UCI. In certain embodiments, the second uplink channel 424 (e.g., a second PUCCH uplink channel, or another uplink channel) is associated with second uplink channel frequency and a P-CSI UCI. In certain embodiments, the third uplink channel 426 (e.g., a PUSCH uplink channel) is associated with a third uplink channel frequency and Other UCI.

Slot 440 is a single slot of 0-N symbols (e.g., N equal to 13 for a total of 14 symbols in slot 440). As shown in FIG. 4A, each uplink channel 422, 424, and 426 overlaps in time over slot 440 and is each is less length in time than slot 440 (e.g., 14 symbols or less).

FIG. 4A includes a reference time A. Reference time A is a reference time associated with the first earliest symbol in time in the single group of overlapping channels 422, 424, and 426. More specifically, in FIG. 4A the first symbol in time for the group of overlapping channels 422, 424, and 426 is the first symbol in third uplink channel 426. It will be appreciated that the UE requires processing time to generate the symbols needed for each UCI associated with each overlapping channel 422, 424, and 426. It will be further appreciated that the processing of each UCI must occur before the UCI is multiplexed into one of the overlapping channels (e.g., a PUSCH or PUCCH uplink channel).

TC1 in FIG. 4A represents a timeline requirement (reference time A to time 410) to generate a number of symbols (e.g., orthogonal frequency division multiplexing (OFDM) symbols) including UCI (e.g., HARQ-ACK, P-CSI, etc.) based on a PDSCH 402 the UE receives from a BS for the earliest uplink channel in time (third uplink channel 426), plus an integer X (e.g., a positive integer representing a number of symbols (e.g., 1 symbol)(e.g., to provide a buffer)(e.g., for a multiplexing determination)). FIG. 4A shows that TC1 is satisfied as every symbol of the PDSCH 402 is received before time 410. It will be appreciated that in certain aspects, a plurality of PDSCHs can be received at a UE without deviating from the scope of the disclosure (e.g. TC1 is satisfied when every symbol of the plurality of PDSCHs are received before time 410).

TC2 in FIG. 4A represents a timeline requirement (reference time A to time 412) to generate a number of symbols for the PUSCH (e.g., data and/or other UCI) based on an uplink grant 406 for the PUSCH the UE receives from a BS (e.g., on a physical downlink control channel (PDCCH)) for the earliest uplink channel in time (third uplink channel 426), plus an integer Y (e.g., a positive integer representing a number of symbols (e.g., 1 symbol) (e.g., to provide a buffer)). FIG. 4A shows that TC2 is satisfied as every symbol of the uplink grant 406 is received before time 412. It will be appreciated that that in certain aspects, a plurality of PDCCHs can be received at a UE without deviating from the scope of the disclosure (e.g. TC2 is satisfied when every symbol of the plurality of PDCCHs are received before time 410).

When TC1 and TC2 are satisfied for a single group of overlapping channels (e.g., each of the plurality of overlapping channels 422, 424, and 426), a UE can multiplex UCI associated with each of the overlapping channels 422, 424, and 426 into slot 440 of a single uplink channel using known multiplexing techniques and transmit the plurality of UCI. For example, the UE may multiplex the UCI onto one of overlapping channels 422, 424, and 426 in the slot 440.

It will be appreciated that calculating TC1 and TC2 for each single group of overlapping channels takes time and processing power. It will be further appreciated that there may be efficiency and throughput gains by including multiple groups of overlapping channels into a single time slot, each group not overlapping in time with another group, but that current techniques are limited to multiplexing a single group of overlapping channels into a single slot. The disclosure provides techniques to transmit the data of a plurality of UCI associated with multiple groups of overlapping channels as described below.

FIG. 4B is a block diagram conceptually illustrating slot allocation for multiple groups of overlapping channels. FIG. 4B shows multiple groups of overlapping channels, the first group of overlapping channels includes a first plurality of overlapping channels 420a-c (e.g., each uplink channel being one of a PUSCH, PUCCH, etc.), and associated with a first plurality of UCI. The second group of overlapping channels includes a second plurality of overlapping channels 430a-c (e.g., each uplink channel being one of a PUSCH, PUCCH, etc.), and associated with a second plurality of UCI. The first group of overlapping channels and the second group of overlapping channels together are referred to as multiple groups overlapping channels. It will be further appreciated that the first group of overlapping channels and the second group of overlapping channels do not overlap in time.

As further shown in FIG. 4B, slot 440 includes 0-N symbols (e.g., N equal to 13 for a total of 14 symbols in slot 440). Slot 440 may be conceptually divided into mini-slots (e.g., mini-slot 442 including 7 symbols and mini-slot 444 including 7 symbols). As shown in FIG. 4B, each uplink channel in the first plurality of overlapping channels 420a-c are all less than mini-slot 442 in time (e.g., 7 symbols or less). Each uplink channel in the second plurality of overlapping channels 430a-c are all less than mini-slot 444 in time (e.g., 7 symbols or less). It will be appreciated that slot 440 may include a plurality of mini-slots. For example, a slot of 14 symbols may include 7 mini-slots, each mini-slot including 2 symbols. While the techniques described herein are described in connection with a slot 440 containing two mini-slots 442 and 444, the disclosure is not so limited and may be applied to three or more mini-slots and three of more groups of overlapping channels without deviating from the scope of the disclosure.

In certain aspects, when there are multiple groups of overlapping channels, a UE uses two timeline requirements (e.g., TC1 and TC2) as described below. FIG. 4B includes a reference time A. Reference time A is a reference time associated with the first earliest symbol in time among the first plurality of overlapping channels 420a-c and the second plurality of overlapping channels 430a-c. In the example shown, reference time A is a reference time associated with the first earliest symbol in time in the first plurality of overlapping channels 420a-c. More specifically, in FIG. 4B the first symbol in time among the first plurality of overlapping channels 420a-c and the second plurality of overlapping channels 430a-c is the first symbol in uplink channel 420c.

TC1 in FIG. 4B represents a timeline requirement (reference time A to time 410) to generate a number of symbols including UCI (e.g., HARQ-ACK, P-CSI, etc.) based on a PDSCH 402 and PDSCH 404 the UE receives from a BS for the earliest uplink channel in time (uplink channel 420c), plus an integer X (e.g., a positive integer representing a number of symbols (e.g., 1 symbol)(e.g., to provide a buffer)). It will be appreciated that PDSCH 402 is associated with the first plurality of overlapping channels 420a-c, and PDSCH 404 is associated with the second plurality of overlapping channels 430a-c. It will be further appreciated that both PDSCH 402 and PDSCH 404 must satisfy TC1 for the timeline requirement of TC1 to be met. FIG. 4B shows that the first plurality of overlapping channels 420a-c and the second plurality of overlapping channels 430a-c satisfy TC1 as every symbol of the PDSCH 402 and the PDSCH 404 is received before time 410.

TC2 in FIG. 4B represents a timeline requirement (reference time A to time 412) to generate a number of symbols for the PUSCH (e.g., data and/or other UCI for UL channel 420c and UL channel 430c) based on an uplink grant 406 for the PUSCH (e.g., UL channel 420c) and the uplink grant 408 for the PUSCH (e.g., UL channel 430c) the UE receives from a BS (e.g., on a PDCCH) for the earliest uplink channel in time (UL channel 420c), plus an integer Y (e.g., a positive integer representing a number of symbols (e.g., 1 symbol)(e.g., to provide a buffer)). It will be appreciated that UL Grant 406 is associated with the first plurality of overlapping channels 420a-c, and UL Grant 408 is associated with the second plurality of overlapping channels 430a-c. It will be further appreciated that both UL Grant 408 and UL Grant 406 must satisfy TC2 for the timeline requirement of TC2 to be met. FIG. 4B shows that the first plurality of overlapping channels 420a-c and the second plurality of overlapping channels 430a-c satisfy TC2 as every symbol of the uplink grants 406 and 408 is received before time 412.

In certain aspects, when a UE uses two time requirements (e.g., TC1 and TC2), and both are satisfied, the UE will multiplex the data from the first plurality of UCI associated with the first plurality of overlapping channels 420a-c and the second plurality of UCI associated with the second plurality of overlapping channels 430a-c into slot 440 (e.g., into a PUCCH or a PDSCH associated with one of the first plurality or second plurality of overlapping channels). In certain aspects, a UE can multiplex the first plurality of UCI into a first mini-slot (e.g., into mini-slot 442) (e.g., into a PUCCH or a PDSCH associated with the first plurality of overlapping channels) and multiplex the second plurality of UCI into a second mini-slot (e.g., into mini-slot 444) (e.g., into a PUCCH or a PDSCH associated with the second plurality of overlapping channels) and transmit the multiplexed data to a BS. If any of the timeline requirements (e.g., any one of TC1-TC2) is not met the UE may determine an error condition.

FIG. 4C is a block diagram conceptually illustrating an example slot allocation for multiple groups of overlapping channels. FIG. 4C shows multiple groups of overlapping channels (e.g., two groups). The first group of overlapping channels includes a first plurality of overlapping channels 420a-c (each uplink channel being one of a PUSCH, PUCCH, etc., and associated with a first plurality of UCI). The second group of overlapping channels includes a second plurality of overlapping channels 430a-c (each uplink channel being one of a PUSCH, PUCCH, etc., and associated with a second plurality of UCI). It will be further appreciated that the first group of overlapping channels and the second group of overlapping channels do not overlap in time.

As shown in the example of FIG. 4C, slot 440 includes 0-N symbols (e.g., N equal to 13 for a total of 14 symbols in slot 440). Slot 440 may be conceptually divided into mini-slots (e.g., mini-slot 442 comprising 7 symbols and mini-slot 444 comprising 7 symbols). In this example, each uplink channel in the first plurality of overlapping channels 420a-c are all less than mini-slot 442 in time (e.g., 7 symbols or less). Each uplink channel in the second plurality of overlapping channels 430a-c are all less than mini-slot 444 in time (e.g., 7 symbols or less). However, in another example, the first group of overlapping channels (e.g., overlapping channels 420a-c) are greater than mini-slot 442 in time (e.g., 7 symbols or more), while another group of overlapping channels (e.g., overlapping channels 430a-c) are less than mini-slot 442 in time (e.g., 7 symbols or less).

In certain aspects, when there are multiple groups of overlapping channels, a UE uses two timeline requirements per group for a total of four timeline requirements (e.g., TC1, TC2 for the first group, and TC3, and TC4 for the second group) as described below. FIG. 4C includes a reference time A. Reference time A is a reference time associated with the first earliest symbol in time in the first plurality of overlapping channels 420a-c. More specifically, in FIG. 4C the first symbol in time for the first plurality of overlapping channels 420a-c is the first symbol in uplink channel 420c. FIG. 4C also includes a reference time B. Reference time B is a reference time associated with the first earliest symbol in time in the second plurality of overlapping channels 430a-c. More specifically, in FIG. 4C the first symbol in time for the second plurality of overlapping channels 430a-c is the first symbol in uplink channel 430b.

TC1 in FIG. 4C represents a timeline requirement (reference time A to time 410) to generate a number of symbols including UCI (e.g., HARQ-ACK, P-CSI, etc.) based on a PDSCH 402 the UE receives from a BS for the earliest uplink channel in time in the first group of overlapping channels (uplink channel 420c), plus an integer X (e.g., a positive integer representing a number of symbols (e.g., 1 symbol) (e.g., to provide a buffer)). As shown, PDSCH 402 is associated with the first plurality of overlapping channels 420a-c and PDSCH 404 is associated with the second plurality of overlapping channels 430a-c. FIG. 4C shows that TC1 is satisfied as every symbol of the PDSCH 402 is received before time 410. It will be appreciated that in certain aspects, a plurality of PDSCHs can be received at a UE without deviating from the scope of the disclosure (e.g. TC1 is satisfied when every symbol of the plurality of PDSCHs are received before time 410).

TC2 in FIG. 4C represents a timeline requirement (reference time A to time 412) to generate a number of symbols for the PUSCH (e.g., data and/or other UCI for UL channel 420c) based on an uplink grant 406 for the PUSCH (e.g., UL channel 420c) the UE receives from a BS (e.g., on a PDCCH) for the earliest uplink channel in time in the first group of overlapping channels (UL channel 420c), plus an integer Y (e.g., a positive integer representing a number of symbols (e.g., 1 symbol) (e.g., to provide a buffer)). It will be appreciated that UL Grant 406 is associated with the first plurality of overlapping channels 420a-c, and UL Grant 408 is associated with the second plurality of overlapping channels 430a-c. FIG. 4B shows that TC2 is satisfied as every symbol of the UL grant 406 is received before time 412. It will be appreciated that that in certain aspects, a plurality of PDCCHs can be received at a UE without deviating from the scope of the disclosure (e.g. TC2 is satisfied when every symbol of the plurality of PDCCHs are received before time 412).

TC3 in FIG. 4C represents a timeline requirement (reference time B to time 414) to generate a number of symbols including UCI (e.g., HARQ-ACK, P-CSI, etc.) based on a PDSCH 404 the UE receives from a BS for the earliest uplink channel in time in the second group of overlapping channels (uplink channel 430b), plus an integer X (e.g., a positive integer representing a number of symbols (e.g., 1 symbol) (e.g., to provide a buffer)). FIG. 4C shows that TC3 is satisfied as every symbol of the PDSCH 404 is received before time 414.

TC4 in FIG. 4C represents a timeline requirement (reference time B to time 416) to generate a number of symbols for the PUSCH (e.g., data and/or other UCI for UL channel 430c) based on an uplink grant 408 for the PUSCH (e.g., UL channel 430c) the UE receives from a BS (e.g., on a PDCCH) for the earliest uplink channel in time in the second group of overlapping channels (UL channel 430b), plus an integer Y (e.g., a positive integer representing a number of symbols (e.g., 1 symbol) (e.g., to provide a buffer)). FIG. 4C shows that TC4 is satisfied as every symbol of the UL grant 408 is received before time 416.

In certain aspects when a UE uses two timeline requirements per group for a total of four timeline requirements (e.g., TC1, TC2 for the first group, and TC3, and TC4 for the second group), and all four are satisfied, the UE will multiplex the data from the first plurality of UCI associated with the first plurality of overlapping channels 420a-c and the second plurality of UCI associated with the second plurality of overlapping channels 430a-c into slot 440 of an uplink channel (e.g., PUCCH or a PDSCH). In certain aspects, a UE can multiplex the first plurality of UCI into a first mini-slot (e.g., into mini-slot 442) (e.g., into a PUCCH or a PDSCH associated with the first plurality of overlapping channels) and multiplex the second plurality of UCI into a second mini-slot (e.g., into mini-slot 444) (e.g., into a PUCCH or a PDSCH associated with the second plurality of overlapping channels) and transmit the multiplexed data to a BS.

It will be appreciated that in certain aspects, the first plurality of overlapping channels 420a-c may fail a timeline requirement (e.g., TC1 or TC2). In this case, a UE may determine to multiplex and transmit the data from the second plurality of UCI associated with the second plurality of overlapping channels 430a-c into slot 440 (e.g., into mini-slot 444) of an uplink channel (e.g., PUCCH or a PDSCH). In certain aspects, the UE may further determine an error condition for the first plurality of overlapping channels 420a-c in such a case.

In other aspects, the second plurality of overlapping channels 430a-c may fail a timeline requirement (e.g., TC3 or TC4). In this case, a UE may determine to multiplex and transmit the data from the first plurality of UCI associated with the first plurality of overlapping channels 420a-c into slot 440 (e.g., into mini-slot 442) of an uplink channel (e.g., PUCCH or a PDSCH). In certain aspects, the UE may further determine an error condition for the second plurality of overlapping channels 430a-c in such a case.

In yet other aspects, if any of the timeline requirements (e.g., any one of TC1-TC4) is not met the UE may determine an error condition.

FIG. 4D is a block diagram conceptually illustrating slot allocation for multiple groups of overlapping channels. FIG. 4D shows multiple groups of overlapping channels (e.g., two groups). The first group of overlapping channels includes a first plurality of overlapping channels 420a-c (e.g., each uplink channel being one of a PUSCH, PUCCH, etc.), and each associated with a first plurality of UCI. The second group of overlapping channels includes a second plurality of overlapping channels 430a-c (e.g., each uplink channel being one of a PUSCH, PUCCH, etc.), and each associated with a second plurality of UCI. It will be appreciated that the first group of overlapping channels and the second group of overlapping channels do not overlap in time.

As further shown in FIG. 4D, slot 440 includes 0-N symbols (e.g., N equal to 13 for a total of 14 symbols in slot 440). Slot 440 may be conceptually divided into mini-slots (e.g., mini-slot 442 comprising 7 symbols and mini-slot 444 comprising 7 symbols).

As shown in FIG. 4D, each uplink channel in the first plurality of overlapping channels 420a-c are all less than mini-slot 442 in time (e.g., 7 symbols or less). Each uplink channel in the second plurality of overlapping channels 430a-c are all less than mini-slot 444 in time (e.g., 7 symbols or less).

In certain aspects, when there are multiple groups of overlapping channels, a UE uses two timeline requirements per group for a total of four timeline requirements (e.g., TC1, TC2 for the first group, and TC3, and TC4 for the second group) as described below. FIG. 4D includes a reference time A. Reference time A is a reference time associated with the first earliest symbol in time in the first plurality of overlapping channels 420a-c. More specifically, in FIG. 4D the first symbol in time for the first plurality of overlapping channels 420a-c is the first symbol in uplink channel 420c.

FIG. 4D also includes a reference time Bx. Reference time Bx (where x is a variable associated with a channel) is a reference time associated with the first earliest symbol in time in the second plurality of overlapping channels 430a-c that allows a timeline requirement to be satisfied. More specifically, in FIG. 4D the first symbol in time for the second plurality of overlapping channels 430a-c is the first symbol in uplink channel 430b (which is shown as reference time B1; however, it will be appreciated that as shown in in FIG. 4D, using a reference time B1 based on uplink channel 430b would result in TC3 (shown as TC3a) not being satisfied. Thus, in certain aspects, the UE can use a reference time B2. Reference time B2 uses the next earliest symbol in time in the second plurality of overlapping channels 430a-c, which in this case is UL Channel 430a.

It will be appreciated that this variable reference time be applied to reference time A without deviating from the scope of the disclosure. In certain aspects, timeline requirements TC1-TC4 are defined the same as in FIG. 4C.

In certain aspects when a UE uses a variable reference time (e.g., where reference time A and reference time B are variable), the UE can multiplex the data from the first plurality of UCI associated with the first plurality of overlapping channels 420a-c that meet the first timeline requirements, and the second plurality of UCI associated with the second plurality of overlapping channels 430a-c that meet the second timeline requirement (e.g., UL channel 430a and 430c, with UL Channel 430b being ignored) into slot 440 of an uplink channel (e.g., PUCCH or a PDSCH). In certain aspects, a UE will multiplex the first plurality of UCI into a first mini-slot (e.g., into mini-slot 442) and multiplex the second plurality of UCI into a second mini-slot (e.g., into mini-slot 444) of an uplink channel.

FIG. 5 is a flow chart conceptually illustrating slot allocation for multiple groups of overlapping channels in accordance with certain aspects of the present disclosure. Method 500 is a method of transmitting uplink control information (UCI) in a single time slot comprising two or more groups of overlapping channels (e.g., UCI associated with UL Channels 420a-c and UCI associated with UL Channels 430a-c in any of FIGS. 4B-4D) by a user equipment, the two or more groups of overlapping channels comprising a first group (e.g., UL Channels 420a-c) and a second group (e.g., UL Channels 430a-c), the first group comprising a first plurality of channels that overlap in time, the second group comprising a second plurality of channels that overlap in time, wherein the first group and the second group do not overlap in time.

At block 502, the UE determines if a first earliest symbol in time corresponding to the first group (e.g., UL Channel 420c) meets at least a first timeline requirement (e.g., TC1) and a second timeline requirement (e.g., TC2).

At block 504, the UE determines if a second earliest symbol in time corresponding to the second group (e.g., UL Channel 430b) meets at least a third timeline requirement (e.g., TC1 or TC3) and a fourth timeline requirement (e.g., TC2 or TC4).

At block 506, when the UE determines that the first earliest symbol meets the first timeline requirement and the second timeline requirement and the second earliest symbol meets the third timeline requirement and fourth timeline requirement: multiplexing and transmitting a first plurality of uplink control information (UCI) on a first channel of the first plurality of channels; and multiplexing and transmitting a second plurality of UCI on a second channel of the second plurality of channels. In certain aspects, the first and second channel are multiplexed into and transmitted on the same type channel, for example a slot (or mini-slot) of a PUCCH or PUSCH channel (e.g., slot 440 and mini-slots 442 and 444 in FIG. 4C).

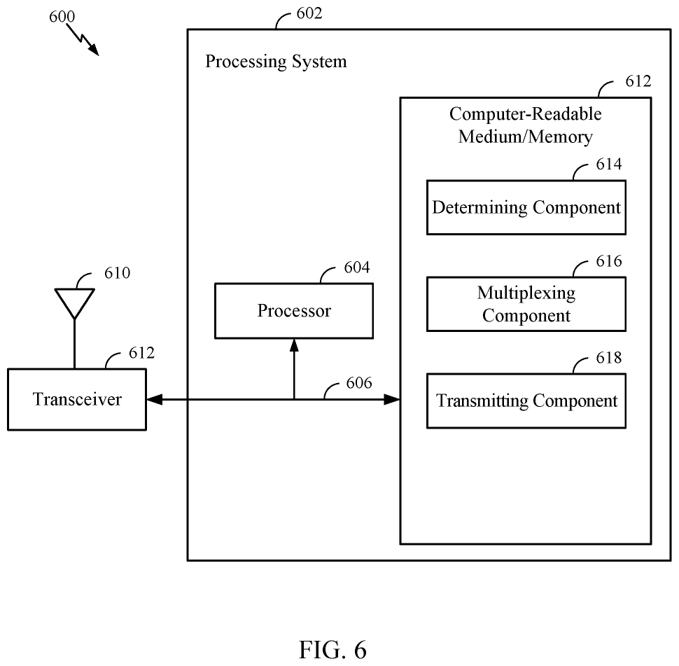

FIG. 6 illustrates a communications device 600 that may include various components (e.g., corresponding to means-plus-function components) configured to perform operations for the techniques disclosed herein, such as the operations illustrated in FIG. 5. The communications device 600 includes a processing system 602 coupled to a transceiver 608. The transceiver 608 is configured to transmit and receive signals for the communications device 600 via an antenna 610, such as the various signal described herein. The processing system 602 may be configured to perform processing functions for the communications device 600, including processing signals received and/or to be transmitted by the communications device 600.

The processing system 602 includes a processor 604 coupled to a computer-readable medium/memory 612 via a bus 606. In certain aspects, the computer-readable medium/memory 612 is configured to store instructions that when executed by processor 604, cause the processor 604 to perform the operations illustrated in FIG. 5, or other operations for performing the various techniques discussed herein.

In certain aspects, the processing system 602 further includes a determining component 614 for performing the operations illustrated in block 502 and 504 of FIG. 5. Additionally, the processing system 602 includes a multiplexing component 616 for performing the operations illustrated in block 506 of FIG. 5. Additionally, the processing system 602 includes a transmitting component 618 for performing the operations illustrated in block 506 of FIG. 5. The determining component 614, multiplexing component 616, and transmitting component 618 may be coupled to the processor 604 via bus 606. In certain aspects, the determining component 614, multiplexing component 616, and transmitting component 618 may be hardware circuits. In certain aspects, the [determining component 614, multiplexing component 616, and transmitting component 618 may be software components that are executed and run on processor 604.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 5.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of transmitting uplink control information (UCI) in a single time slot comprising two or more groups of overlapping channels by a user equipment (UE), the two or more groups of overlapping channels comprising a first group and a second group, the first group comprising a first plurality of channels that overlap in time, the second group comprising a second plurality of channels that overlap in time, wherein the first group and the second group do not overlap in time, the method comprising:
determining if a first earliest symbol in time corresponding to the first group meets at least a first timeline requirement and a second timeline requirement;
determining if a second earliest symbol in time corresponding to the second group meets at least a third timeline requirement and a fourth timeline requirement;
when the first earliest symbol meets the first timeline requirement and the second timeline requirement and the second earliest symbol meets the third timeline requirement and fourth timeline requirement:
multiplexing and transmitting a first plurality of uplink control information (UCI) on a first channel of the first plurality of channels; and
multiplexing and transmitting a second plurality of UCI on a second channel of the second plurality of channels.

2. The method of claim 1, wherein the first timeline requirement comprises an end of a first physical downlink shared channel (PDSCH) being received at the UE at least a first number of symbols in time required for UE processing of the first PDSCH before the start of the first earliest symbol, and
wherein the third timeline requirement comprises an end of a second PDSCH being received at the UE at least a second number of symbols in time required for UE processing of the second PDSCH before the start of the second earliest symbol.

3. The method of claim 2, wherein the first number of symbols equals the second number of symbols.

4. The method of claim 1, wherein the second timeline requirement comprises an end of a first physical downlink control channel (PDCCH) scheduling uplink transmission on a first physical uplink shared channel (PUSCH) for the UE being received at the UE at least a first number of symbols in time required for UE processing of the first PDCCH before the start of the first earliest symbol;
wherein the fourth timeline requirement comprises an end of a second PDCCH scheduling uplink transmission on a second PUSCH for the UE being received at the UE at least a second number of symbols in time required for UE processing of the second PDCCH before the start of the second earliest symbol; and
wherein the first PUSCH comprises the first group, and the second PUSCH comprises the second group.

5. The method of claim 4, wherein the first number of symbols equals the second number of symbols.

6. The method of claim 1, wherein the first timeline requirement is different than the third timeline requirement and the second timeline requirement is different than the fourth timeline requirement, and further comprising:
determining an error condition when at least one of:
the first earliest symbol does not meet the first timeline requirement or the second timeline requirement; or
the second earliest symbol does not meet the third timeline requirement or the fourth timeline requirement.

7. The method of claim 1, wherein the first timeline requirement is different than the third timeline requirement and the second timeline requirement is different than the fourth timeline requirement, and further comprising:
determining an error condition for the first plurality of channels when the first earliest symbol does not meet the first timeline requirement or the second timeline requirement;
multiplexing and transmitting the first plurality of UCI on the first channel of the first plurality of channels when the first earliest symbol meets the first timeline requirement and the second timeline requirement;
determining an error condition for the second plurality of channels when the second earliest symbol does not meet the third timeline requirement or the fourth timeline requirement; and
multiplexing and transmitting the second plurality of UCI on the second channel of the second plurality of channels when the second earliest symbol meets the third timeline requirement and the fourth timeline requirement.

8. The method of claim 1, wherein the first timeline requirement is different than the third timeline requirement and the second timeline requirement is different than the fourth timeline requirement, and further comprising:
multiplexing and transmitting a portion of the first plurality of UCI on the first channel of the first plurality of channels when the first earliest symbol does not meet the first timeline requirement or the second timeline requirement, wherein an earliest symbol of the first channel meets the first timeline requirement and the second timeline requirement;
multiplexing and transmitting the first plurality of UCI on the first channel of the first plurality of channels when the first earliest symbol meets the first timeline requirement and the second timeline requirement;
multiplexing and transmitting a portion of the second plurality of UCI on the second channel of the second plurality of channels when the second earliest symbol does not meet the third timeline requirement or the fourth timeline requirement, wherein an earliest symbol of the second channel meets the third timeline requirement and the fourth timeline requirement; and
multiplexing and transmitting the second plurality of UCI on the second channel of the second plurality of channels when the second earliest symbol meets the third timeline requirement and the fourth timeline requirement.

9. The method of claim 1, wherein the first timeline requirement comprises an end of a first physical downlink shared channel (PDSCH) being received at the UE at least a first number of symbols in time required for UE processing of the first PDSCH before the start of the first earliest symbol,
wherein the second timeline requirement comprises an end of a first physical downlink control channel (PDCCH) scheduling uplink transmission on a first physical uplink shared channel (PUSCH) for the UE being received at the UE at least a second number of symbols in time required for UE processing of the first PDCCH before the start of the first earliest symbol, and
wherein the first number of symbols is different than the second number of symbols.

10. A user equipment (UE), comprising:
a memory; and
a processor communicatively coupled to the memory, wherein the processor is configured to:
transmit uplink control information (UCI) in a single time slot comprising two or more groups of overlapping channels, the two or more groups of overlapping channels comprising a first group and a second group, the first group comprising a first plurality of channels that overlap in time, the second group comprising a second plurality of channels that overlap in time, wherein the first group and the second group do not overlap in time;
determine if a first earliest symbol in time corresponding to the first group meets at least a first timeline requirement and a second timeline requirement;
determine if a second earliest symbol in time corresponding to the second group meets at least a third timeline requirement and a fourth timeline requirement;
when the first earliest symbol meets the first timeline requirement and the second timeline requirement and the second earliest symbol meets the third timeline requirement and fourth timeline requirement:
multiplex and transmit a first plurality of uplink control information (UCI) on a first channel of the first plurality of channels; and
multiplex and transmit a second plurality of UCI on a second channel of the second plurality of channels.

11. The UE of claim 10, wherein the first timeline requirement comprises an end of a first physical downlink shared channel (PDSCH) being received at the UE at least a first number of symbols in time required for UE processing of the first PDSCH before the start of the first earliest symbol; and
wherein the third timeline requirement comprises an end of a second PDSCH being received at the UE at least a second number of symbols in time required for UE processing of the second PDSCH before the start of the second earliest symbol.

12. The UE of claim 11, wherein the first number of symbols equals the second number of symbols.

13. The UE of claim 10, wherein the second timeline requirement comprises an end of a first physical downlink control channel (PDCCH) scheduling uplink transmission on a first physical uplink shared channel (PUSCH) for the UE being received at the UE at least a first number of symbols in time required for UE processing of the first PDCCH before the start of the first earliest symbol;
wherein the fourth timeline requirement comprises an end of a second PDCCH scheduling uplink transmission on a second PUSCH for the UE being received at the UE at least a second number of symbols in time required for UE processing of the second PDCCH before the start of the second earliest symbol; and
wherein the first PUSCH comprises the first group, and the second PUSCH comprises the second group.

14. The UE of claim 13, wherein the first number of symbols equals the second number of symbols.

15. The UE of claim 10, wherein the first timeline requirement is different than the third timeline requirement and the second timeline requirement is different than the fourth timeline requirement; and
wherein the processor is further configured to determine an error condition when at least one of:
the first earliest symbol does not meet the first timeline requirement or the second timeline requirement; or
the second earliest symbol does not meet the third timeline requirement or the fourth timeline requirement.

16. The UE of claim 10, wherein the first timeline requirement is different than the third timeline requirement and the second timeline requirement is different than the fourth timeline requirement; and
wherein the processor is further configured to:
determine an error condition for the first plurality of channels when the first earliest symbol does not meet the first timeline requirement or the second timeline requirement;
multiplex and transmit the first plurality of UCI on the first channel of the first plurality of channels when the first earliest symbol meets the first timeline requirement and the second timeline requirement;
determine an error condition for the second plurality of channels when the second earliest symbol does not meet the third timeline requirement or the fourth timeline requirement; and
multiplex and transmit the second plurality of UCI on the second channel of the second plurality of channels when the second earliest symbol meets the third timeline requirement and the fourth timeline requirement.

17. The UE of claim 10, wherein the first timeline requirement is different than the third timeline requirement and the second timeline requirement is different than the fourth timeline requirement, and
wherein the processor is further configured to:
multiplex and transmit a portion of the first plurality of UCI on the first channel of the first plurality of channels when the first earliest symbol does not meet the first timeline requirement or the second timeline requirement, wherein an earliest symbol of the first channel meets the first timeline requirement and the second timeline requirement;
multiplex and transmit the first plurality of UCI on the first channel of the first plurality of channels when the first earliest symbol meets the first timeline requirement and the second timeline requirement;
multiplex and transmit a portion of the second plurality of UCI on the second channel of the second plurality of channels when the second earliest symbol does not meet the third timeline requirement or the fourth timeline requirement, wherein an earliest symbol of the second channel meets the third timeline requirement and the fourth timeline requirement; and
multiplex and transmit the second plurality of UCI on the second channel of the second plurality of channels when the second earliest symbol meets the third timeline requirement and the fourth timeline requirement.

18. The UE of claim 10, wherein the first timeline requirement comprises an end of a first physical downlink shared channel (PDSCH) being received at the UE at least a first number of symbols in time required for UE processing of the first PDSCH before the start of the first earliest symbol;
wherein the second timeline requirement comprises an end of a first physical downlink control channel (PDCCH) scheduling uplink transmission on a first physical uplink shared channel (PUSCH) for the UE being received at the UE at least a second number of symbols in time required for UE processing of the first PDCCH before the start of the first earliest symbol; and
wherein the first number of symbols is different than the second number of symbols.

19. A non-transitory computer-readable storage medium that stores instructions that when executed by a user equipment (UE) cause the UE to perform a method of transmitting uplink control information (UCI) in a single time slot comprising two or more groups of overlapping channels by a UE, the two or more groups of overlapping channels comprising a first group and a second group, the first group comprising a first plurality of channels that overlap in time, the second group comprising a second plurality of channels that overlap in time, wherein the first group and the second group do not overlap in time, the method comprising:
determining if a first earliest symbol in time corresponding to the first group meets at least a first timeline requirement and a second timeline requirement;
determining if a second earliest symbol in time corresponding to the second group meets at least a third timeline requirement and a fourth timeline requirement;
when the first earliest symbol meets the first timeline requirement and the second timeline requirement and the second earliest symbol meets the third timeline requirement and fourth timeline requirement:
multiplexing and transmitting a first plurality of uplink control information (UCI) on a first channel of the first plurality of channels; and
multiplexing and transmitting a second plurality of UCI on a second channel of the second plurality of channels.

20. The non-transitory computer-readable storage medium of claim 19, wherein the first timeline requirement comprises an end of a first physical downlink shared channel (PDSCH) being received at the UE at least a first number of symbols in time required for UE processing of the first PDSCH before the start of the first earliest symbol, and
wherein the third timeline requirement comprises an end of a second PDSCH being received at the UE at least a second number of symbols in time required for UE processing of the second PDSCH before the start of the second earliest symbol.

21. The non-transitory computer-readable storage medium of claim 20, wherein the first number of symbols equals the second number of symbols.

22. The non-transitory computer-readable storage medium of claim 19, wherein the second timeline requirement comprises an end of a first physical downlink control channel (PDCCH) scheduling uplink transmission on a first physical uplink shared channel (PUSCH) for the UE being received at the UE at least a first number of symbols in time required for UE processing of the first PDCCH before the start of the first earliest symbol;
wherein the fourth timeline requirement comprises an end of a second PDCCH scheduling uplink transmission on a second PUSCH for the UE being received at the UE at least a second number of symbols in time required for UE processing of the second PDCCH before the start of the second earliest symbol; and
wherein the first PUSCH comprises the first group, and the second PUSCH comprises the second group.

23. The non-transitory computer-readable storage medium of claim 22, wherein the first number of symbols equals the second number of symbols.

24. The non-transitory computer-readable storage medium of claim 19, wherein the first timeline requirement is different than the third timeline requirement and the second timeline requirement is different than the fourth timeline requirement; and
wherein the method further comprises determining an error condition when at least one of:
the first earliest symbol does not meet the first timeline requirement or the second timeline requirement; or
the second earliest symbol does not meet the third timeline requirement or the fourth timeline requirement.

25. The non-transitory computer-readable storage medium of claim 19, wherein the first timeline requirement is different than the third timeline requirement and the second timeline requirement is different than the fourth timeline requirement, and wherein the method further comprises:
determining an error condition for the first plurality of channels when the first earliest symbol does not meet the first timeline requirement or the second timeline requirement;
multiplexing and transmitting the first plurality of UCI on the first channel of the first plurality of channels when the first earliest symbol meets the first timeline requirement and the second timeline requirement;
determining an error condition for the second plurality of channels when the second earliest symbol does not meet the third timeline requirement or the fourth timeline requirement; and
multiplexing and transmitting the second plurality of UCI on the second channel of the second plurality of channels when the second earliest symbol meets the third timeline requirement and the fourth timeline requirement.

26. The non-transitory computer-readable storage medium of claim 19, wherein the first timeline requirement is different than the third timeline requirement and the second timeline requirement is different than the fourth timeline requirement, and wherein the method further comprises:
multiplexing and transmitting a portion of the first plurality of UCI on the first channel of the first plurality of channels when the first earliest symbol does not meet the first timeline requirement or the second timeline requirement, wherein an earliest symbol of the first channel meets the first timeline requirement and the second timeline requirement;
multiplexing and transmitting the first plurality of UCI on the first channel of the first plurality of channels when the first earliest symbol meets the first timeline requirement and the second timeline requirement;
multiplexing and transmitting a portion of the second plurality of UCI on the second channel of the second plurality of channels when the second earliest symbol does not meet the third timeline requirement or the fourth timeline requirement, wherein an earliest symbol of the second channel meets the third timeline requirement and the fourth timeline requirement; and
multiplexing and transmitting the second plurality of UCI on the second channel of the second plurality of channels when the second earliest symbol meets the third timeline requirement and the fourth timeline requirement.

27. The non-transitory computer-readable storage medium of claim 19, wherein the first timeline requirement comprises an end of a first physical downlink shared channel (PDSCH) being received at the UE at least a first number of symbols in time required for UE processing of the first PDSCH before the start of the first earliest symbol,
wherein the second timeline requirement comprises an end of a first physical downlink control channel (PDCCH) scheduling uplink transmission on a first physical uplink shared channel (PUSCH) for the UE being received at the UE at least a second number of symbols in time required for UE processing of the first PDCCH before the start of the first earliest symbol, and
wherein the first number of symbols is different than the second number of symbols.

28. A user equipment (UE), comprising:
a means for transmitting uplink control information (UCI) in a single time slot comprising two or more groups of overlapping channels by a UE, the two or more groups of overlapping channels comprising a first group and a second group, the first group comprising a first plurality of channels that overlap in time, the second group comprising a second plurality of channels that overlap in time, wherein the first group and the second group do not overlap in time;
a means for determining if a first earliest symbol in time corresponding to the first group meets at least a first timeline requirement and a second timeline requirement;
a means for determining if a second earliest symbol in time corresponding to the second group meets at least a third timeline requirement and a fourth timeline requirement;
when the first earliest symbol meets the first timeline requirement and the second timeline requirement and the second earliest symbol meets the third timeline requirement and fourth timeline requirement:
a means for multiplexing and transmitting a first plurality of uplink control information (UCI) on a first channel of the first plurality of channels; and
a means for multiplexing and transmitting a second plurality of UCI on a second channel of the second plurality of channels.

29. The UE of claim 28, wherein the first timeline requirement comprises an end of a first physical downlink shared channel (PDSCH) being received at the UE at least a first number of symbols in time required for UE processing of the first PDSCH before the start of the first earliest symbol, and
wherein the third timeline requirement comprises an end of a second PDSCH being received at the UE at least a second number of symbols in time required for UE processing of the second PDSCH before the start of the second earliest symbol.

30. The UE of claim 28, wherein the second timeline requirement comprises an end of a first physical downlink control channel (PDCCH) scheduling uplink transmission on a first physical uplink shared channel (PUSCH) for the UE being received at the UE at least a first number of symbols in time required for UE processing of the first PDCCH before the start of the first earliest symbol;
wherein the fourth timeline requirement comprises an end of a second PDCCH scheduling uplink transmission on a second PUSCH for the UE being received at the UE at least a second number of symbols in time required for UE processing of the second PDCCH before the start of the second earliest symbol; and
wherein the first PUSCH comprises the first group, and the second PUSCH comprises the second group.
